(19) United States
(12) Patent Application Publication
(10) Pub. No.: US 2007/0121902 A1
(43) Pub. Date: May 31, 2007

(54) TRANSFER OF LIVE CALLS

(76) Inventors: Andrei Stoica, Farmington Hills, MI (US); Ilya Abezgauz Druzhnikov, Davis, CA (US)

Correspondence Address: ELLIOT FURMAN, 15 WEST 81ST STREET #11J, NEW YORK, NY, 10024, US

(21) Appl. No.: 11/556,301

(22) Filed: Nov. 3, 2006

Related U.S. Application Data
(60) Provisional application No. 60/732,993, filed on Nov. 3, 2005.
(60) Provisional application No. 60/811,571, filed on Jun. 6, 2006.

(51) Int. Cl. H04M 3/00; H04M 5/00

(52) U.S. Cl. 379/265.11

(57) ABSTRACT

A system and a method for facilitating a call connection between a talker and a target. The system includes a database that maintains a list of lead data of one or more targets and an exchange module that maintains real-time connectivity between a caller and the talker after the caller and the talker are registered with the exchange module. The system further includes at least one caller module that places at least one of a call set up request and a call transfer request to the exchange module. The call transfer request is placed when the target is located on the call. The caller module further communicates with the database to obtain the lead data of the target after the call set up. At least one talker module instantly receives the call from the exchange module in response to the call transfer request by the caller module along with the lead data of the target.

This application claims the benefit of U.S. Provisional Application No. 60/732,993, filed Nov. 3, 2005, and U.S. Provisional Application No. 60/811,571, filed Jun. 6, 2006, both of which are hereby incorporated by reference.

### BACKGROUND OF THE INVENTION

In a modem business environment where companies rely on other companies to provide goods and services, a company can stagnate, or worse, go out of business, if they are unable to sell their goods and services. Thus, in typical business-to-business sales scenarios, salespeople and account managers work long and hard to identify, contact, and speak with people who have actual decision making ability when it comes to purchasing goods and services for a company. A sales pitch to the wrong person inevitably becomes a sale that is never made. So, when reaching out to potential buyers, it is desirable and often essential to contact the actual decision maker or makers—the people who can say yes, or say no, to a sale.

Contacting decision makers is, unfortunately, not always as simple as it initially appears. Many hours or even weeks are lost by the salesperson in an effort to reach a decision maker. During this time the salesperson may navigate a maze of gatekeepers, that is, people and systems that stand between the salesperson and the decision maker. Just a few examples of gatekeepers include, secretaries, procurement managers, interactive voice response systems, voice mail systems, and the like. In addition to the time spent interacting with the gatekeepers, there may also be additional time spent waiting for the decision maker to pick up a call; sometimes the decision maker will simply let calls go to voicemail.

Since the company representative trying to sell the goods or services is typically a skilled salesperson, sometimes with years of experience and in-depth product knowledge, their time is a highly valued. Therefore, organizations often prefer to use less trained and less expensive “callers” to arrange or place the call to the decision makers or leads and navigate to the decision maker. These callers may hand off the call to a salesperson only when a decision maker is actually reached.

However, in handing off the call to the salesperson, the caller must typically put the decision maker on hold and then call the salesperson, who upon answering the call is connected to the decision maker. While this optimizes the use of the salesperson's time, it is very irritating to the decision maker who may even hang up the call while on hold. Thus, not only is the instant opportunity of communicating with the decision maker lost, but the decision maker may also be disinclined to communicate in the future. Additionally, manually transferring the call, from the caller-decision maker to the salesperson-decision maker, often results in a loss of call information, that is information about the decision maker and the potential sale; in some cases the salesperson may have only incomplete call information and thus be caught completely off-guard and unready to make a sale when the call is transferred.

Thus, a need exists for a system and method for instantly transferring a call so that a caller can connect a salesperson to a decision maker, without the decision maker ever knowing that the caller was involved. Furthermore, there is a need for a system and method that transfers complete call information to the salesperson when the call is transferred. And, there is a need for a system and method that ensures effective utilization of the company representative's time.

### BRIEF DESCRIPTION OF DRAWINGS

FIG. 1 illustrates an exemplary environment to practice various embodiments of the present invention.

FIG. 2 shows a functional block diagram of a call handling system in accordance with an embodiment of the present invention.

FIG. 3 shows another detailed functional block diagram of the call handling system in accordance with an embodiment of the present invention.

FIG. 4 shows a method for facilitating a call connection between a talker and a target for a campaign in accordance with an embodiment of the present invention.

FIG. 5 illustrates the steps of preparing the campaign in accordance with an embodiment of the present invention.

FIG. 6 illustrates the steps of registering the callers and the talkers with the exchange module in accordance with an embodiment of the present invention.

FIG. 7 illustrates the steps of assigning the target to the caller in accordance with an embodiment of the present invention.

FIGS. 8a and 8b illustrate the steps of switching the call instantly to the talkers in accordance with an embodiment of the present invention.

FIG. 9 shows an exemplary interface of the administrator's login screen.

FIG. 10 shows an exemplary interface of the caller's login screen.

FIG. 11 shows an exemplary interface of the talker's login screen.

FIG. 12 shows an exemplary interface of the administrator module to enable the administrator to import new leads into the database or modify existing leads.

FIG. 13 shows an exemplary interface of the administrator module to allow the administrator to select the leads from the database for a campaign.

FIG. 14 shows an exemplary interface of the administrator module showing a newly created campaign.

FIG. 15 shows an exemplary interface of the administrator module which allows the administrator to monitor information on a campaign in real-time.

FIG. 16 shows an exemplary interface of the caller module.

FIG. 17 shows an exemplary interface of the talker module when the talker is on the call with the target.

FIG. 18 shows an exemplary interface of the talker module when the talker has finished the call with the target.

### SUMMARY

The present provides a system for facilitating a call connection between a talker and a target. The system includes a database that maintains a list of lead data of one or more targets and an exchange module that maintains real-time connectivity between a caller and the talker after the caller and the talker are registered with the exchange module. The system further includes at least one caller module that places at least one of a call set up request and a call transfer request to the exchange module, wherein the call transfer request is placed when the target is located on the call. The caller module further communicates with the database to obtain the lead data of the target after the call is set up. At least one talker module instantly receives the call from the exchange module in response to the call transfer request by the caller module along with the lead data of the target.

In accordance with an embodiment, the present invention provides a method for facilitating a call connection between a talker and a target. The method maintains real-time connectivity between a caller and the talker after the caller and the talker are registered. Further, the method receives a call set up request from the caller and provides the lead data of the target after the call set up to the caller. Thereafter, the method receives a call transfer request from the caller when the target is located on the call after navigation and instantly switches the call from the caller to the talker in response to the call transfer request along with the lead data of the target.

In accordance with an embodiment, the present invention provides a computer program product comprising a computer readable medium including a computer readable program, such that the computer readable program when executed on a computer causes the computer to maintain real-time connectivity between a caller and the talker after the caller and the talker are registered; receive a call set up request from the caller and provide the lead data of the target after the call set up to the caller; receive a call transfer request from the caller when the target is located on the call after navigation; and instantly switch the call from the caller to the talker in response to the call transfer request along with the lead data of the target.

The foregoing paragraphs have been provided by way of general introduction, and they should not be used to narrow the scope of the following claims.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the invention. The appearance of the phrases “in an embodiment”, “in one embodiment”, and “in another embodiment”, in various places in the specification, does not necessarily refer to the same embodiment.

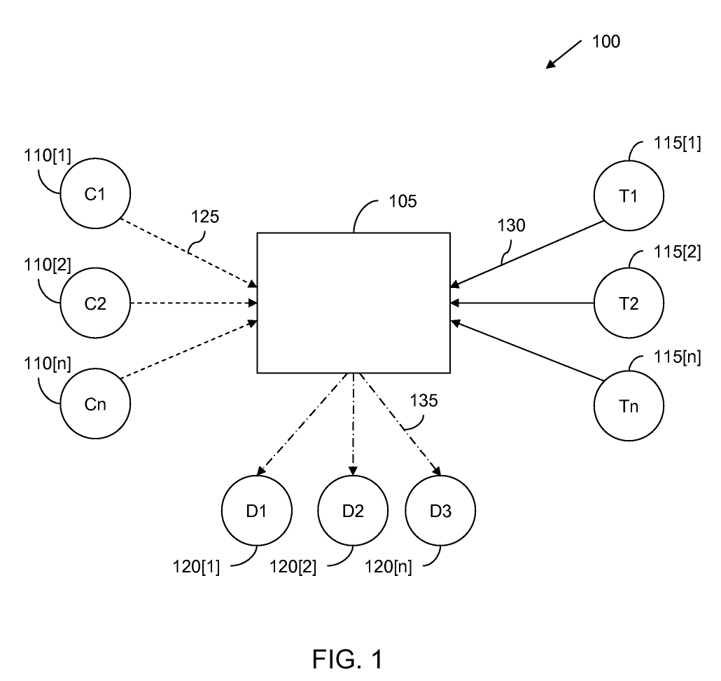

FIG. 1 illustrates an exemplary environment 100 to practice various embodiments of the present invention. The environment 100 includes a call handling system 105, a plurality of callers 110[1-n], a plurality of talkers 115[1-n], and a plurality of targets 120[1-n]. The callers 110, talkers 115, and targets 120 are connected to call handling system 105 via connections 125, 130, and 135 respectively.

In various embodiments, callers 110 are people who initiate a call and navigate through a variety of people and systems to reach a target. The variety of people and systems includes Interactive Voice Response (IVR) systems, bad connections, operators, receptionists, secretaries, voice mail, automated voice response systems, and other systems that handle calls. These people and systems that stand between the callers 110 and the targets 120 are called gatekeepers. The gatekeepers may assist or hinder a caller in reaching a target. Thus, the callers 110 navigate the gatekeepers and upon reaching a target, such as a decision maker, transfers the call to a talker, such as a salesperson.

As already understood, the callers 110 may be lower paid and lower skilled than the talkers 114, and do not need to be familiar with the particular task or objective of calling the targets 120 (for example, to make a sale, communicate important information, provide technical services, and the like), or knowledgeable about products or services. At the most basic level, they only know the name or the position of the target they are trying to contact.

The talkers 115, in contrast to the callers 110, are people who are familiar with and skilled in a particular task (for example, technical information about a product) or the objective of the call (for example, selling a product or service). The talkers 115 may include one or more salespersons, technical consultants, counselors, account managers, and the like. Furthermore, being skilled, the talkers 115 are capable of providing more convincing and valuable thoughts, suggestions, arguments, sales pitches, and the like over a voice connection with the targets 120.

The targets 120 are the people with whom the call is being set up. The targets 120, for example, are decision makers who are capable of making decisions related to buying or selling products or services, end users, destined receivers of information, and the like. Callers may alternatively be referred to as “surveyors” or “agents”, and talkers may alternatively be referred to as “pitchers.”

Through a computer-based interface which will be disclosed in detail later, the callers 110 request the call handling system 105 to initiate a call with one of the targets 120. A list of targets is maintained by the call handling system, however, it is often the case that the telephone numbers of the targets results in a call to a gatekeeper. Once the call is initiated, the callers 110 navigate through phone trees, bad connections, operators, receptionists, voice mail, automated voice responses, and the like, to connect to the targets 120. Once the target is located, in response to a call transfer request placed by the caller's computer-based interface, the call handling system 105 switches the call to one of the available talkers 115. The call handling system 105 switches the call with no perceived time lag, delay, or noise so that the target is completely unaware that it was a caller who navigated the gatekeepers to reach him. Thereafter, the talker converses with the target to perform a task or meet an objective, for example, sales and marketing of a product, providing technical services, and the like.

In the event that the caller is unable to contact the target, the caller may end the call, after which the call handling system 105 automatically chooses another target from the list of targets and connects a call with the target for the caller. Multiple callers may call multiple targets in the list; a single caller may make calls to a multiplicity of unrelated targets. Information about the targets is displayed on the caller interface, and complementary talker interface displays call information and target information when a call is transferred. These details will be disclosed below.

Thus, the connections 125, 130, and 135 connect callers 110, talkers 115, and targets 120 respectively to call handling system 105. In various embodiments, connections 125, 130, and 135, are circuit-switched connections for example, the Public Switched Telephone Network (PSTN) connections, packet-switched connections for example, Voice over Internet Protocol (VoIP) connections, Integrated Services Digital Network (ISDN) connections, and the like, or any combination of these. The signaling protocol for the VoIP connections include, without limitation, a Session Initiation Protocol (SIP), an Inter-Asterisk Exchange (IAX) protocol, H.323 protocol, and the like.

In an embodiment of the present invention, the callers 110, and the talkers 115 may be located in distinct geographical locations. A geographical location may be a country, city, state, domicile, region, or the like. The callers 110 and the talkers 115 may be coupled to call handling system 105 via an Internet connection, a wireless broadband connection, or some other type of high speed wired or wireless data connection. They may also be coupled to the call handling system 105 via the PSTN or other voice network or data network. Typically, the targets are coupled to a PSTN network. The call handling system 105 may be located at one of the callers' site, the talkers' site, or a third-party location.

So, as is probably understood in light of the foregoing disclosure, the present invention may be practiced in an industry wherein talkers 115 include salespersons selling one or more products or services, callers 110 may be the assistants to the salespersons, and targets 120 may be the decision makers who are capable of buying the services or products. Callers 110 are provided with the data of the targets or gatekeepers. The call handling system automatically calls leads associated with the desired target and connects the calls to the callers 110. Callers 110, if necessary, navigate the gatekeepers, and when they reach the target, they cause the call handling system to connect the targets to the talkers. Thereafter, the salesperson attempts to effectuate a sale of, for example, products or services to the target.

In one embodiment, the call handling system maintains a list of campaigns. Each campaign may represent a sales effort for a different product or service, and each campaign may be for different and unrelated companies. Thus, each campaign will have a different list of target leads, and callers 110 may be calling different and unrelated individuals and companies to reach different and unrelated targets 120, and transferring calls to different and unrelated talkers 115.

While various embodiments of the present invention have been illustrated using an outbound calling support for sales of products or services, it should be apparent to one skilled in the art that the teachings of the present invention may be employed to any system that needs an outbound calling support.

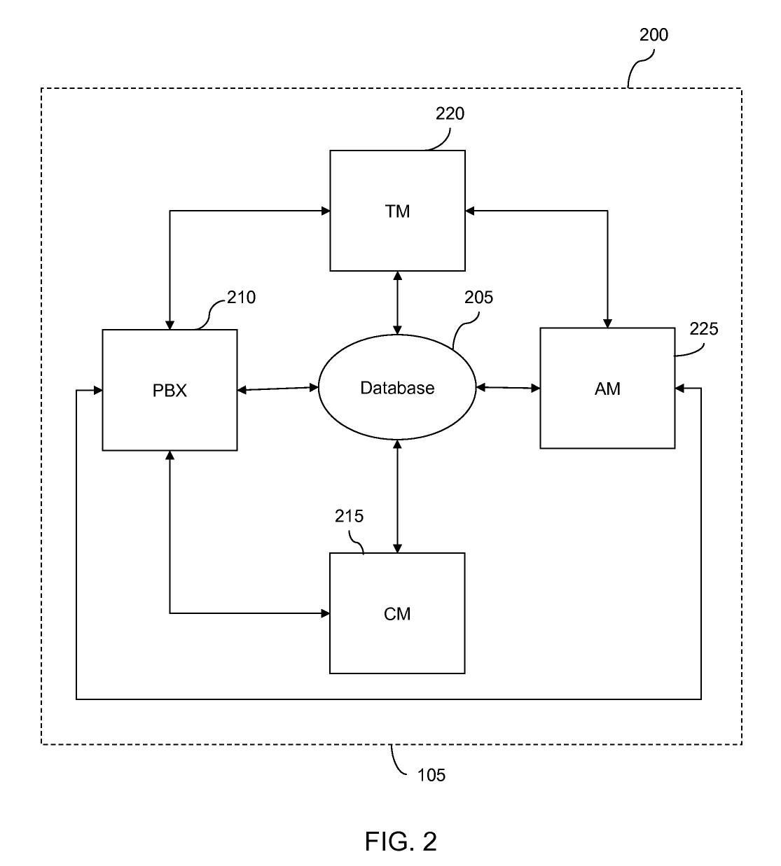

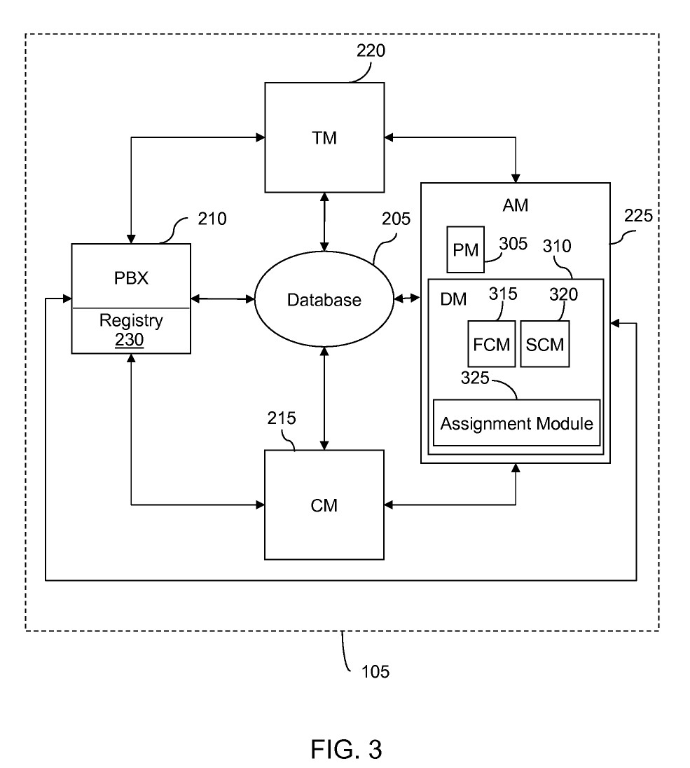

Turning now to FIG. 2, one embodiment of a functional block diagram 200 of the call handling system 105 is shown. The call handling system 105 includes a database 205, an exchange module (PBX) 210, at least one caller module (CM) 215, at least one talker module (TM) 220, and an administrator module (AM) 225. The exchange module 210 may further include a registry module 230 (shown in FIG. 3).

Caller module 215 is coupled to exchange module 210, database 205, and administrator module 225. Caller module 215 is accessed by one of the callers (110 of FIG. 1), and every caller (110 of FIG. 1) is in communication with and interacts with a caller module 215. Talker module 215 is coupled to database 205, exchange module 210, and administrator module 225. Talker module 220 is accessed by one of the talkers (115 of FIG. 1), and every talker (115 of FIG. 1) is in communication with and interacts with a talker module 220). Administrator module 225 is coupled to database 205, exchange module 210, and talker module 220. In this embodiment, there is no direct connection between the administrator module 225 and the caller module 215, however, through the following disclosure it will become evident to those skilled in the art that a direct connection, as well as other connections whether direct or indirect between other modules are possible while remaining within the scope of the present invention.

Typically, each talker (115 of FIG. 1) is provided with a telephone/headset and a computer. The talker module 220 executes on the talker's computer for communicating data, while the telephone/headset is connected to the exchange module 210 over the PSTN or a VoIP network for communicating voice. Also, typically, each caller (110 of FIG. 1) is provided with a telephone/headset and a computer. The caller module 215 executes on the caller's computer for communicating data, and the telephone/headset is connected to the exchange module 210 over the PSTN of a VoIP network for communicating voice. Furthermore, typically, an administrator or campaign manager is provided a computer on which the administrator module 225 is executed. Administrator module 225 monitors and manages voice and data connections between the talker modules 220, caller modules 215, and exchange module 210. Administrator module 225 also allows an administrator to view real-time information on campaigns and calls. Also, administrator module 225 provides command signals for controlling exchange module 210, talker module 220, and optionally, caller module 215. Additionally, the administrator module 225, as well as the talker module 220 and the caller module 215 reads from and write to the database 205 in varying capacities which will be discussed. As can be appreciated, this is only one exemplary configuration of the disclosed elements of call handling system 105, and other configurations are possible within the scope of the present invention.

Back to FIG. 2, the connections between the caller module 215, the talker module 215, the database 205, and the administrator module 225 enable communication and exchange of voice, data, command signals such as call set up requests and call transfer requests, lead data of the targets 120, and the like between the database 205, the exchange module 210, the caller module 215, the talker module 220, and the administrator module 225.

Lead data is the information relating to a lead or a target. Examples of lead data include target designation or name, company, phone numbers, and other identifying information. At a minimum, lead data includes the name of the target or the position of the target, and a phone number. The call set up request comprises a request placed by a caller to initiate calls. The call transfer request comprises a request placed by a caller to transfer a call to a talker.

Database 205 stores and exchanges lead data of the targets 120 with exchange module 210, caller module 215, talker module 220, and administrator module 225. Database 205 is a repository that stores and maintains a list of the lead data of one or more targets, of one or more campaigns. The list includes lead data of the targets 120 to be called during a campaign. The lead data may include information such as target identification, phone number, name of person, availability information of the target, information about navigation, time zones, personal data, scripts, dispositions of the target, and the like. In an embodiment, database 205 is a relational database that supports Standard Query Language (SQL). In another embodiment, database 205 is an online database maintained by a third party service provider.

In an embodiment, database 205 is capable of sharing, interacting, and exchanging commercially important information such as, without limitation, lead data for specific companies, telephone numbers, and the like, with third party databases connected via a network. Examples of networks include without limitation, the Internet, a Wide Area Network (WAN), a Local Area Network (LAN), and the like. Private, public, and online database may be combined and/or simultaneously accessed to provide additional lead data.

Exchange module 210 connects caller module 215 and talker module 220 via a voice connection. Exchange module 210 comprises a phone exchange, such as a software private branch exchange, that enables real-time call connection and call transfer between the talkers 115, callers 110, and targets 120. As will be discussed, the real-time call connection and transfer are enabled after a talker (115 of FIG. 1) and a caller (110 of FIG. 1) are registered with the call handling system 105.

Connectivity is referred to as real-time since any caller, talker, or target can be instantly connected to one another. By “instantly” it is meant that the connectivity between callers, talkers, and targets can be broken, established, or transferred in a time substantially imperceptible to a person, such as the target. In one embodiment, the time it takes to instantly transfer a call from a caller to a talker, and connect that talker to a target is less than one half of one second.

Further, the exchange module 210 facilitates data connections between caller module 215, talker module 220, and database 205 for exchanging the lead data with database 205. The exchange module 210 also enables the lead data to be transferred between the talkers 115, callers 110, and database 205.

In one embodiment, upon logging in to the call handling system (105 of FIGS. 1 and 2) through their respective caller module 215 or talker module 220, and/or through their respective telephones, exchange module 210 allocates an extension number to each logged in caller (110 of FIG. 1) and talker (115 of FIG. 1). By allocating an extension number, a voice line is reserved at exchange module 210 for the exclusive use of the logged in caller or talker. The extension numbers are stored in the registry module 230. In another embodiment, the caller and the talker log in using a dummy extension number and the exchange module 210 registers the dummy extension number in the registry module 230. As shown in FIG. 3, in one embodiment, the exchange module 210 comprises the registry module 230. It will be appreciated however, that the registry module 230, or another module equivalent to the registry module 230 may be separate from the exchange module 210, may comprise part of the database 205, may comprise part of the administrator module 225, or the like. In all cases, the callers 110 or the talkers 115 log in to the system 105 and upon logging, are registered with the exchange module 210 and given extensions onto which voice communications can be directed and switched.

Once logged in and registered, calls and data can be transferred between the extensions. Exchange module 210 connects callers 110 and talkers 115 via a dedicated voice connection in real-time. In one embodiment, the dedicated voice connection is provided by a PRI (Primary Rate Interface) T1 line connected to exchange module 210. As a matter of background, a PRI line has 24 lines, 23 of them are voice/data connection and one is a signaling/control connection. Of course, other interfaces and connections can be used separately or in combination, and many more voice lines can be supported with the present invention.

Exchange module 210 includes, without limitation, a software private branch exchange (PBX), and a voice over Internet protocol (VoIP) hosted exchange module to control and monitor the voice/data connections. One such software PBX is Asterisk. Asterisk is an open source telephony switching and PBX daemon, and is well understood by those having ordinary skill in the art. Asterisk runs on computer servers supported by operating systems such as Linux. Asterisk supports many industry standard VoIP and telephony switching protocols, and can interoperate with almost all standards-based telephony equipment.

In one embodiment, exchange module 210 is a software module that is supported by a server running a Real Time Operating System (RTOS) such as FreeRTOS, Phoenix-RTOS, and the like. As a matter of background, the RTOS is an operating system that is designed to better handle real-time inputs. The RTOS allows priorities to be changed instantly and data to be processed in real-time such that the results may be used in response to another process taking place at the same time, as in transaction processing.

In another embodiment, exchange module 210 is a VoIP hosted PBX service such as Palavon virtual PBX. The virtual PBX allows the calls to be made via VoIP connections. In various embodiments of the present invention, a third party service provider hosts the exchange module 210. Hence, the third party service provider provides the call transfer and other PBX functions under the control of at least some of talker module 220, caller module 215, and administrator module 225.

Exchange module 210 also receives command signals such as call set up requests from caller module 215. In one embodiment, caller module 215 places the call set up request directly to the exchange module 210. In another embodiment, the caller module 215 places the call set up request via the administrator module 225 to the exchange module 210.

In either case, caller module 215 enables caller (110 of FIG. 1) to cause exchange module 210 to dial a number of leads in the list, connect the call to the caller, transfer calls to talkers (115 of FIG. 1) whenever a decision maker is reached, and enter lead data and disposition information relating to the call. The disposition information for a lead includes any indicators, and actions that should be considered before or while dialing a lead. Examples of disposition information, also referred to as disposition data, include ‘do not call’, ‘wrong name’, ‘abrupt rejection’, ‘disconnected’, ‘answering machine’, ‘busy tone’, ‘call back’, ‘call back at’, and the like. In an embodiment, caller module 215 provides a list of predefined dispositions that can be selected by the caller through the caller module interface. In another embodiment, caller module 215 allows custom dispositions to be entered.

During a call, and/or when a call has ended, caller module 215 may update the lead data and dispositions in the database to better represent the outcome of the call. Once a call has ended, caller module 215 receives a new lead from database 205, and exchange module 210 dials the number for the new lead. In one embodiment, caller module 215 accesses the list in the database and obtains a new lead, and the administrator module ensures that the lead is a new lead by accessing registry module 230. In another embodiment, the administrator module 225 accesses the list and provides a new lead to caller module 215. In still another embodiment, after caller module 215 received the new lead, it is administrator module 225 that commands exchange module 210 to dial the number of the new lead.

Sometimes, as already mentioned, the caller successfully reaches the voicemail of the target, rather than the live target. In this case, caller module 215 enables the caller to leave a prerecorded voice message or series of messages for the target. In one embodiment, the voice messages are recorded in the voice of the talker and stored digitally as part of the database. The voice messages can be used in a predefined sequence as a follow up to the previous voice message to the target. Further, the talker can set a minimum time interval between the two consecutive voice messages to the target.

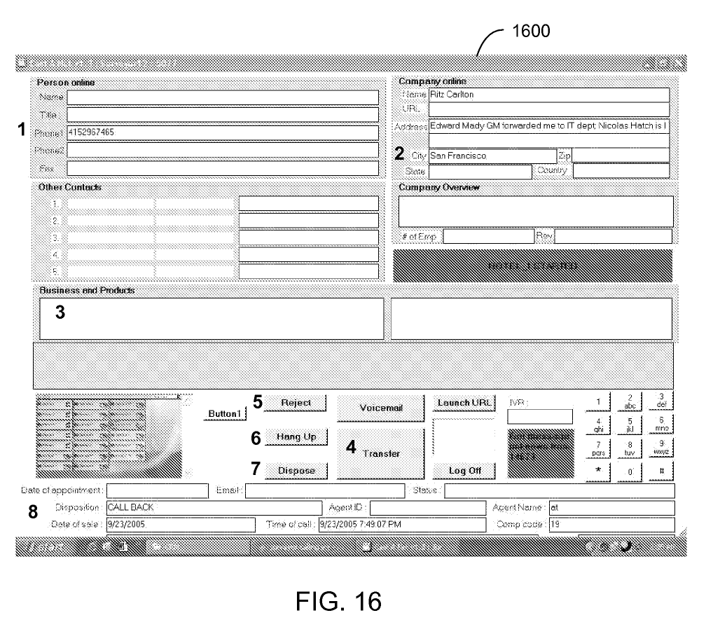

Now, that caller module 215 has been disclosed in detail, turn now to FIG. 10 and FIG. 16. As mentioned, in one embodiment, caller module 215 comprises a software module that provides the caller an interface to the call handling system.

FIG. 10 shows an exemplary interface of the caller's login screen 1000. The interface 1000 includes areas for the caller to specify for example, a role, a name, a team, a campaign, and further includes a button to log in to the system, or to exit. Also included is a check box to specify that the calls should be recorded. If checked, some or all of the caller's call will be digitally recorded and stored. In one embodiment, the calls are stored in the database.

FIG. 16 shows an exemplary interface 1600 of the caller module. The interface includes fields, buttons, and boxes for entering and displaying information such as the name of the target, company details, notes, dispositions. The interface also includes buttons for rejecting a call, hanging up a call, transferring a call, sending a voicemail, and the like. The interface may also display a script (not shown). The script is provided as part of the lead data and provides a preset statement that the caller can read when speaking with gatekeepers.

Referring to the “Transfer” button of FIG. 16, the caller selects this button immediately upon hearing the voice or greeting of the target. This sends the above described call transfer request, which causes the exchange to instantly transfer the call, and for lead data to be sent to the talker module. Because the transfer is instant, the target is unaware that the caller initiated the call. The talker then immediately starts conversing with the target. Typically, the talker hears on the telephone/headset the very end of the target's greeting. For example, if the target is Joe Smith, the caller would hear “Hello, this is Joe Sm . . . ”, then hit transfer, and the talker would hear “ . . . ith,” at which time the talker immediately begins his pitch. The talker is able to begin the pitch instantly as the lead data is displayed to the talker by the talker module. Thus, the talker has all of the information necessary to make a pitch, as well as a voice connection with the target, that is, the decision maker.

Also, as mentioned, once the caller causes the call to be transferred, the caller module receives a new lead and the exchange dials the number of the new lead, and the caller attempts to navigate to the target of the new lead.

Now, referring back to FIG. 2, talker module 220 enables the talker to receive the call from the exchange module 210 in response to the call transfer request by caller module 215, along with the lead data of the target. Talker module 220 also enables the talker to maintain call notes, update the list of the lead data of the targets, and dispose the call with various dispositions. The notes may include, without limitation, textual, verbal, visual, or audio, and other data.

In an embodiment, talker module 220 enables the talker to define dispositions. In another embodiment, the talker can add dispositions to a list of predefined dispositions. Further, the talker may modify the predefined dispositions. Modifications to the lead data, either by talker module 220 or by caller module 215 are communicated to and stored in database 205.

In an embodiment, the talkers provide a list of the lead data of the targets to be called in the form of tabulated data. Examples of tabulated data include, without limitation, a spreadsheet, an XML file, a comma delimited file, and the like. The tabulated data is then uploaded into database 205. Administrator module 225 uploads the tabulated data into database 205. Further, the administrator module 225 may clean, reformat, add lead identification information, and the like, to the tabulated data before uploading the list. In another embodiment, talker module 220 is enabled by the administrator module 225 to upload the tabulated data into database 205. Talker module 220 may update, add, and remove, and otherwise modify the lead data of one or more targets (120 of FIG. 1) present in the list. The caller and talker may also update the lead data during a call.

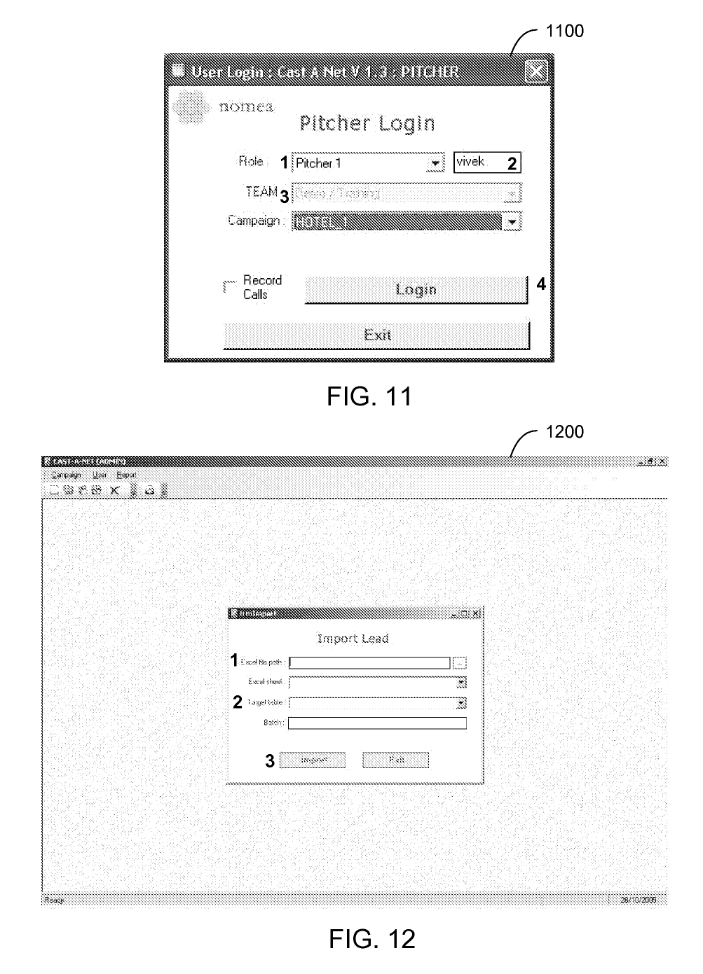

As with caller module 215, talker module comprises a software module that provides the talker an interface to the system to carry out the above described functions. With this in mind, turn to FIGS. 11, 17, and 18.

FIG. 11 shows an exemplary interface of the talker's login screen 1100. The interface 1100 enables the talker to specify, for example, a role, a name, a team name, and also includes a button to log in to the system, or exit. Also included is a check box to specify that the calls should be recorded. If checked, some or all of the talker's call may be digitally recorded and stored. In one embodiment, the calls are stored in the database.

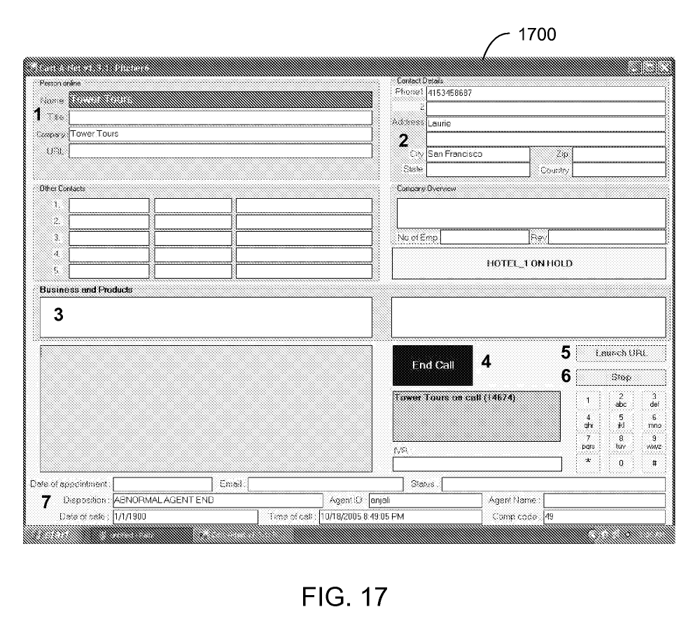

FIG. 17 shows an exemplary interface 1700 of the talker module when the talker is on the call with the target, that is, after the caller transferred the call. The interface includes fields, buttons, and boxes for entering and displaying information such as the name of the target, company details, notes, dispositions, and other forms of lead data discussed in various embodiments above. The interface also includes a button for ending the call. Additionally, the interface may also include other buttons (not shown), such as a play button which signals the administrator module and/or exchange module that the talker is available to receive call transfers, a pause button which signals the administrator module and/or exchange module that the talker is, although being logged in, temporarily unavailable to receive call transfers, and a stop button which logs out the talker. Another button called a problem button (not shown) may be provided. The caller selects the problem button if there was a technical problem with the call, such as poor sound quality. This opens a dialog box into which the talker can describe the problem and submit it to the administrator by way of the administrator module.

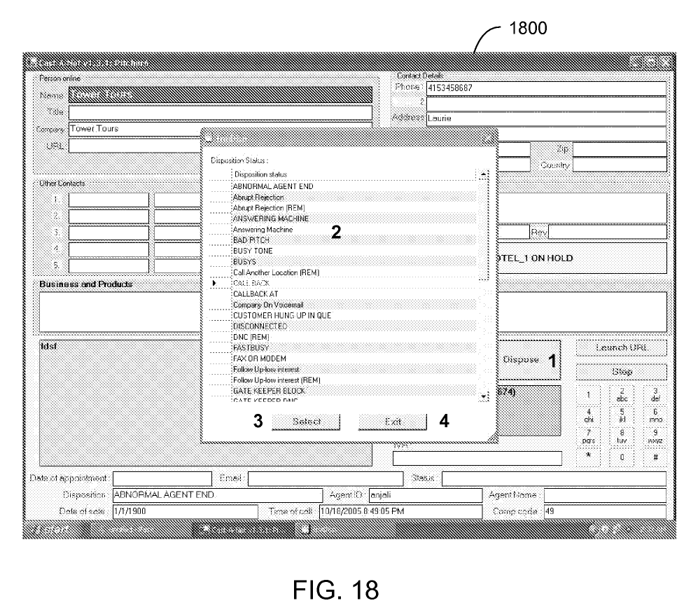

FIG. 18 shows an exemplary interface 1800 of the talker module when the talker has finished the call with the target, and specifically shows a window comprised of a multitude of predefined dispositions that the talker may select.

Turning again back to FIG. 2, as already discussed in some detail, administrator module 225 controls, monitors, and displays various aspects of caller module 215, talker module 220, and exchange module 210. For example, administrator module 225 identifies and displays the callers and/or talkers that have logged into the system. Administrator module 225 also prepares a campaign by selecting the lead data of the targets in database 205,. Administrative module 225 further distributes the leads associated with a campaign to callers 110 via the caller modules 215. In an embodiment, administrative module 225 enables an administrator to pause, stop, and restart a campaign. Administrator module 225 may load the lead data of the targets into database 205 and/or update the list of the targets for example, by deleting a target.

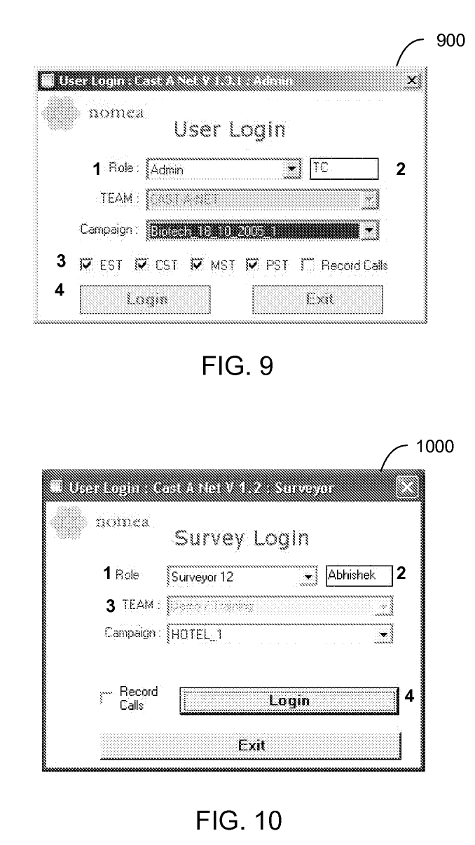

Administrator module 225 comprises a software module that provides an interface to the administrator to carry out various tasks. With this in mind, turn to FIGS. 9, 12, 13, 14, and 15.

FIG. 9 shows an exemplary interface of the administrator's login screen 900 to the administrator module. The interface 900 enables the administrator to specify for example, a role, a name, a team name, and also includes a button to log in to the system, or exit. Also included is a check box to specify calls should be recorded. Further included are check boxes to specify which time zones the campaign should operate in.

FIG. 12 shows an exemplary interface 1200 of the administrator module to enable the administrator to import the new leads into the database 205 or modify the existing leads. The interface 1200 allows the administrator to store and load the information at a specified location in the database 205.

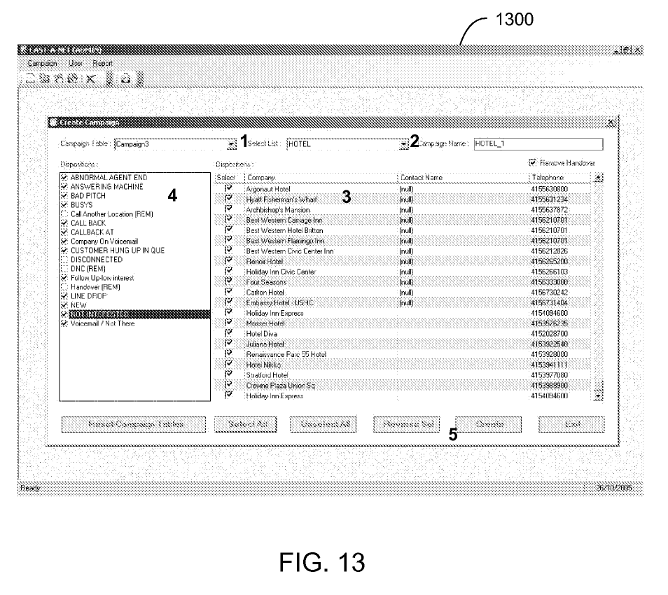

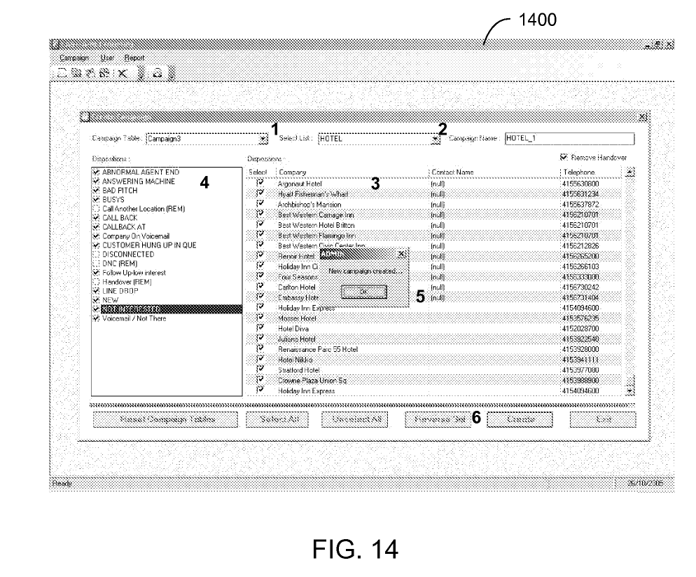

FIG. 13 shows an exemplary interface 1300 of the administrator module to allow the administrator to select the leads from the database for the campaign. In this exemplary embodiment, the administrator may also narrow or expand the selection according to dispositions. FIG. 14 shows an exemplary interface 1400 of the administrator module showing a newly created campaign.

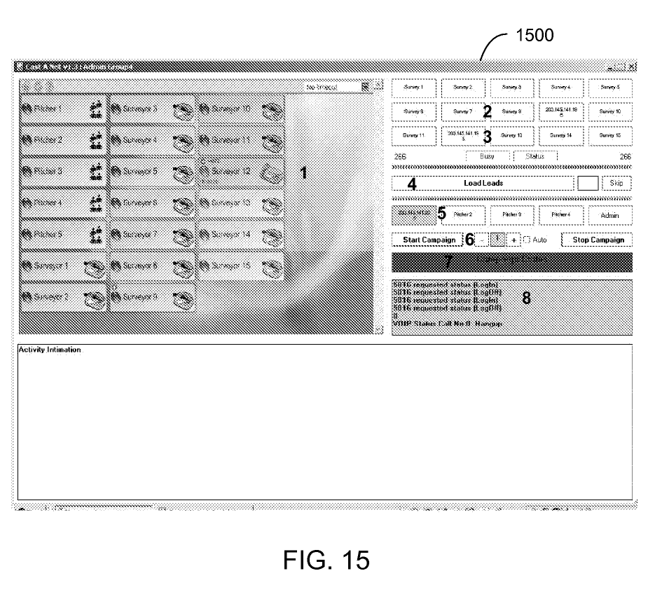

FIG. 15 shows an exemplary interface 1500 of the administrator module which allows the administrator to monitor the information on a campaign in real-time. In this embodiment, the status of callers and talkers are displayed, the number of leads left is displayed, IP addresses of the callers are displayed, and the like. Buttons are also provided for starting and stopping the campaign.

Looking back at FIG. 2, in one embodiment, database 205, exchange module 210, caller module 215, talker module 220, and administrator module 225 reside in the memory of one or more data processing devices. Those skilled in the art will appreciate that various forms of data processing devices may be employed in various embodiments of the present invention including, without limitation, personal computers, servers, mainframes, Personal Digital Assistants (PDA), mobile devices, wireless devices, cell phones, and the like. The data processing devices comprise at least one central processing unit (CPU), support circuits, and memory. The CPU comprises at least one microprocessor or microcontroller. Support circuits are well-known circuits that support the operation of the CPU including but not limited to, power supplies, clocks, cache, input/output circuits, network interfaces, and the like. Memory may include dynamic or static random access memory, flash and other non-volatile memory, magnetic or optical data storage disks and devices, magnetic data storage tapes, and the like. Other processing and memory means, including various computer readable media, may be used for storing and executing program instructions. The memory comprises an operating system (OS). The OS and other software may comprise various executable application modules. The teachings of the present invention may be embodied in the form of computer readable program code that is executable on data processing device.

FIG. 3 shows another detailed functional block diagram of the call handling system 105, in accordance with an embodiment of the present invention. In addition to the modules described in FIG. 2, FIG. 3 illustrates alternative details of administrator module 225. Administrator module 225 includes a polling module 305 (PM), and a distribution module 310 (DM). The distribution module 310 comprises a first checking module 315 (FCM), a second checking module 320 (SCM), and an assignment module 325. Polling module 305 polls exchange module 210 to determine the status of each talker (i.e. whether they are available to talk). Polling module 305 polls for the status of each talker module 220 after a predefined time interval, for example, every 10 seconds. In another embodiment, the polling module 305 receives updates from each talker module 220 and optionally each caller module 215 module, and optionally receives information from the exchange module 210 and/or the registry module 230. That is, any or all of the talker module 220, the caller module 215, the exchange module 210 and the registry module 230 may occasionally actively send updates to the polling module 305.

In all cases, polling module 305 thus determines port numbers and IP address of talker modules 220, and reads other data such as request lead numbers (RL#) which are numbers corresponding to a request for lead data in database 205 , on-line status, availability status, and the like. Additionally, polling module 305 determines the same data for the caller modules 215.

Once, administrator module (225 of FIG. 2) determines the status of talker module 220 and/or caller module 215, the distribution module 310 distribute the calls to the talker modules and/or the caller modules respectively. The first checking module 315 checks whether the request lead number received from polling module 305 conforms to a request lead number stored by the administrator module (225 of FIG. 2). Thereafter, second checking module 320 determines whether a talker module (220 of FIG. 2) is available. Assignment module 325 assigns lead data to the caller module corresponding to a new lead after checking if the first check is unsuccessful and the second check is successful.

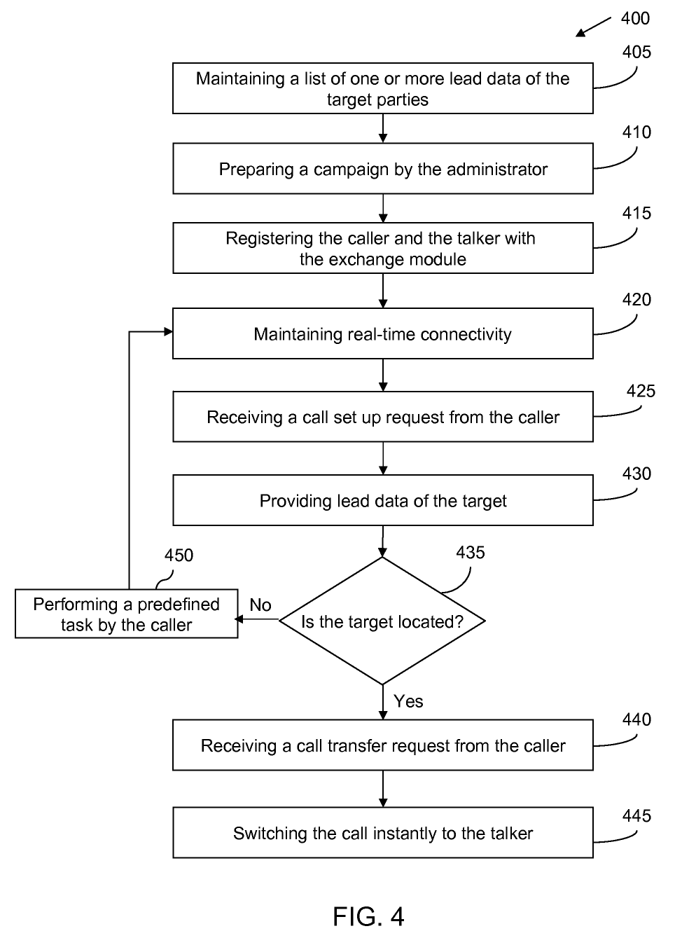

FIG. 4 shows a method 400 for facilitating a call connection between a talker and a target for a campaign in accordance with an embodiment of the present invention. At step 405, the call handling system maintains a list of one or more lead data of the target parties in the database. The maintaining includes, without limitation, collecting, updating and storing the lead data in the database. The lead data may include, without limitation, name of the target, the company name, job title, designation in the company, technical expertise, phone number, address, Uniform Resource Locator (URL), time zone, frequency of calls, notes taken during the call, and the like. The administrator module stores a unique identifier for each lead of the list.

At step 410, the administrator module prepares the campaign using the lead data of a target or targets present in the database. In an embodiment, the preparation 410 includes selecting a list of preferable callers and talkers for the target. At step 415, the callers and the talkers register themselves with the exchange module. The caller module comprises a user interface that enables the callers to log in and register themselves with the call handling system. In one embodiment, when the caller logs in to the system, the caller module uses a dummy extension to register the caller with the exchange module. Similarly, when the talker logs in to the system, the talker module uses another dummy extension to register the caller with the exchange module. Once the callers and the talkers are registered, real-time connectivity is maintained between them at step 420.

As already mentioned, the callers and the talkers may be located in distinct geographical areas, or in the same geographical area. In either case, due to real-time connectivity between them, call and data transfers take place instantly. At step 425, the call handling system receives a call set up request from a registered caller. The user interface of the caller module enables the registered caller to place the call setup request. Once the call setup request is received, calls are automatically set up, placed, made, or dialed, and directed to the caller according to the lead data in the list.

At step 430, and after the call is automatically set up in response to the call set up request, the call handling system provides the lead data to the registered caller corresponding to a target. In one embodiment of the invention, the exchange module provides a lead number to the caller module. The caller module uses the lead number to locate and then access the lead data from the database.

The registered caller then navigates through the target locations in order to reach the target. As defined above, the navigation through the target locations may include, without limitation, talking to the receptionist, talking to one or more human parties, listening to a voicemail greeting of the target, interacting with an Interactive Voice Response (IVR) Telecom applications, and the like.

In one embodiment of the invention, a voice recognition system is provided to navigate through the IVR system. Thus, only when the call reaches a voicemail or a human agent, it is transferred to the registered caller. The registered caller may use his judgment to determine whether the call reached the voicemail or the human agent. There are many prior-art voice recognitions systems that can be employed with the present invention.

In one embodiment of the invention, the registered caller may update the lead data using the caller module while navigating through the target locations. In this way, the lead data is kept current and up-to-date so that when the target is reached, the talker is able to access the latest information associated with the lead.

At step 435, the registered caller determines whether the target is located during navigation. As mentioned, this is determined by the registered caller through the content of the conversations, the voice of the person the caller is speaking to, a greeting when the person answers the phone, and may also be determined at least semi-automatically through the aforementioned voice recognition systems, and the like.

If the determination is successful, the call handling system receives a call transfer request from the caller in step 440. As already disclosed, a “Transfer” button, or equivalent, is provided on the caller module interface accessed by the registered caller. By clicking the transfer button, a call transfer request is generated. The exchange module of the call handling system instantly switches the call to the talker in response to the call transfer request at step 445. Synchronously, the talker module receives the lead data of the target for the talker's reference. The talker may update the lead data while on or after the call.

If the check (step 435) is unsuccessful, the caller may perform a predefined task at step 450. In various embodiments of the invention, the predefined tasks include rejecting a call corresponding to a target, redialing the call to the target, placing the call on hold, leaving a pre-recorded message, disposing of the call, pausing the call, taking notes, and the like. For example, if a secretary of the target informs the caller that the target will be available in 5 minutes to take a call, the caller may redial the target number after the specified time or dispose of the call so that it is automatically dialed in 5 minutes. As already discussed, when the target's voicemail is reached, the caller module enables the caller to leave a prerecorded voice message. In one embodiment of the invention, the voice messages are recorded in the voice of the talker. Further, the talker can set a minimum time interval between the two or more consecutive voice messages to the target. Thereafter, the caller may send a new call set up request and the method repeats with step 425.

In some cases during navigation, the target or a gatekeeper provides an alternative lead which is entered into the system through the talker module or the caller module, and the administrator module checks whether the alternative lead is present in the database. If the check is unsuccessful, the talker module or the caller module may add the alternative lead to the database. Furthermore, the alternate lead can be associated with the original lead so when the alternate lead is eventually contacted, the talker is aware of the history of the calls. And, the alternate lead can be associated with the original lead so that the original lead is no longer called.

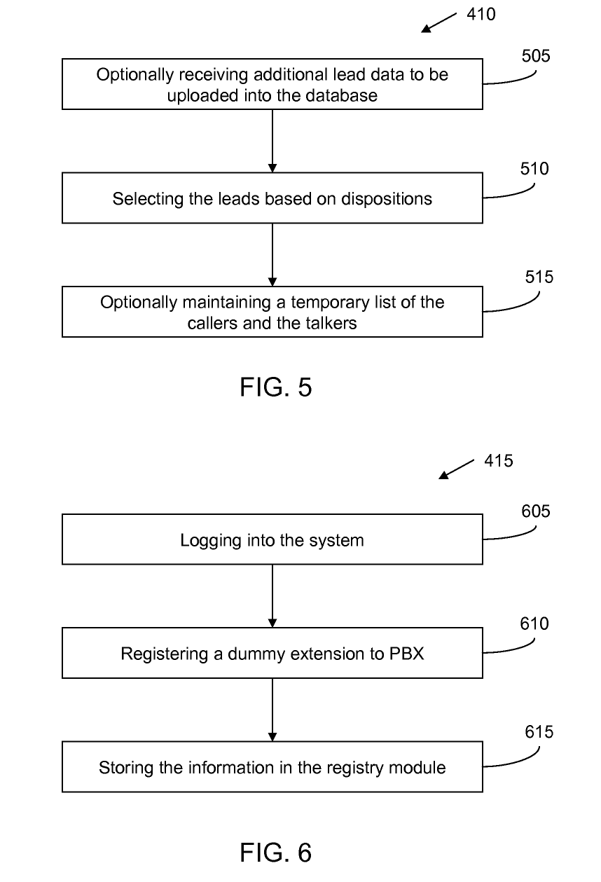

FIG. 5 illustrates the sub-steps of preparing the campaign (step 410 of FIG. 4) according to an embodiment of the present invention. At step 505, the call handling system optionally receives additional lead data from the administrator to be uploaded in the database. The administrator uploads the additional lead data using the administrator module. In one embodiment of the invention, the administrator may add, edit or remove the lead data associated with a target before starting the campaign.

At step 510, the administrator module selects the targets for the campaign. The selection of the targets may be based on the disposition information associated with the targets. For example, the talker may provide the disposition information obtained during a previous call with the target indicating that the target should not be called again. In one embodiment, the administrator may individually select or deselect the leads to work for the campaign At optional step 515, the administrator module maintains a temporary list of the callers and the talkers who participate in the campaign. In one embodiment, the temporary list may be based on, without limitation, qualifications, technical skills, experience, linguistic capabilities, and the like. In one embodiment of the invention, the temporary list may be based on a schedule provided by the talker. Similarly, the temporary list may be based on a schedule provided by the caller. The schedule may include, without limitation, time to start the call to a lead, availability of the talkers, and the like. In one embodiment, the talker may update his schedule in a calendar accessible by the administrator. The administrator module may use the temporary list during selection of the talker or a caller for a target.

FIG. 6 illustrates the sub-steps of registering the callers and the talkers with the exchange module (step 415 of FIG. 4), according to an embodiment of the present invention. At step 605, the caller logs in to the system using the caller module. At step 610, the caller module uses a dummy extension number, for example, “6106”, to register an extension with the exchange module. This reserves an extension for use by the caller. At step 615, the exchange module stores the registration. The registration details include, without limitation, the extension number, IP address of the caller's computer, port, and the like. When the caller requests for the target assignment, the caller module updates a Request Lead Number (RL#) in the registry module (or equivalent).

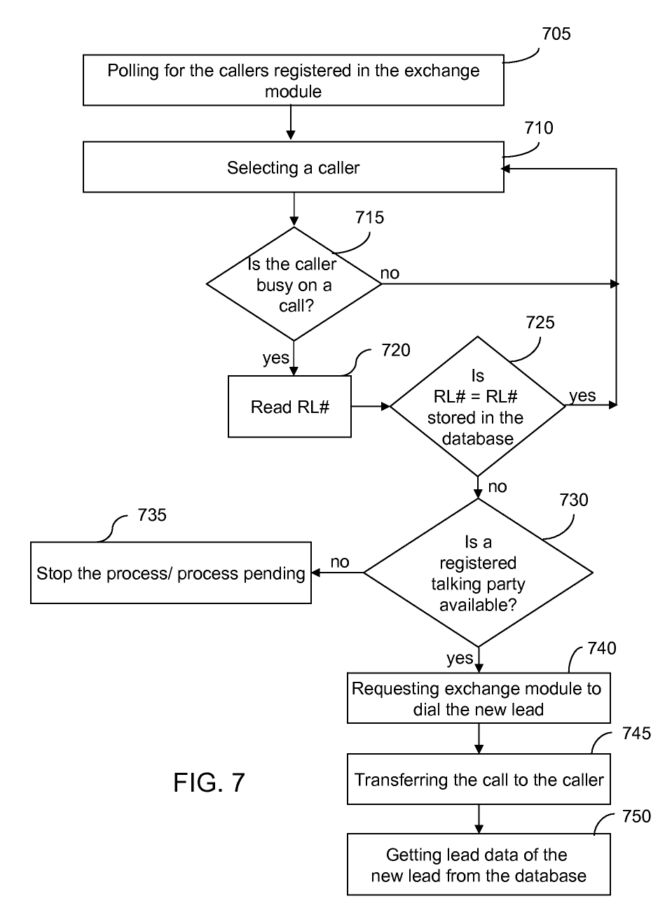

FIG. 7 illustrates one embodiment of a method for assigning a target to a caller according to an embodiment of the present invention. At step 705, the administrator module polls for the callers registered with the exchange module. As discussed above, this determines the status of each caller. The registry module provides a list of the callers currently logged in to the system. The administrator module determines the IP addresses and ports of the available callers through the polling. In one embodiment, the administrator module polls for the available callers at regular intervals. At step 710, the administrator module selects the first available caller from the list of available callers. Alternatively, the selection of the caller may be based on various criteria such as the longest idle time, random selection, or the skill-set.

At step 715, the administrator module checks whether the selected caller is busy, for example, on a call or on hold. If the check is successful, that is, the selected caller is on a call or on hold, a different caller is selected (step 710). If the selected caller is available, the administrator module reads the request lead number (RL#) of a target (step 720).

At step 725, the administrator module checks whether the RL# corresponding to the target is same as the RL# stored in the database against the extension number corresponding to the caller. If they are the same, then the administrator module interprets that the caller has already been given the lead and selects a new caller (step 710).

If the RL# is different (step 725), then the caller is requesting a new lead. In this case, the administrator module determines whether a registered talker is available (step 730). If a talker is not available, the administrator module may either stop the process or place the process on hold until a talker registers with the call handling system (step 735). If the talker is available (step 730), the administrator module selects the next target from the database and requests the exchange module to call the target corresponding to the new lead (step 740). At step 745, the exchange module calls the next lead and transfers the call to the selected caller. In one embodiment of the invention, the exchange module indicates the call connection to the selected caller via a beep on the caller's phone/headset, and optionally, by displaying the status of the connection on the caller module interface.

At step 750, the caller module obtains the lead data from the database. In one embodiment of the invention, the exchange module provides the lead number to the caller module. The caller uses the lead number to look up the lead data in the database. Further, the administrator module updates the RL# in the database against the caller's extension number. So, the call is dialed (step 740), the call is transferred to the caller (step 745), and lead data for the call is also obtained (step 750). The lead data is displayed on the interface of the caller module along with the status of the call. The caller can then navigate to find the target, all the while taking notes and updating the lead data, if necessary.

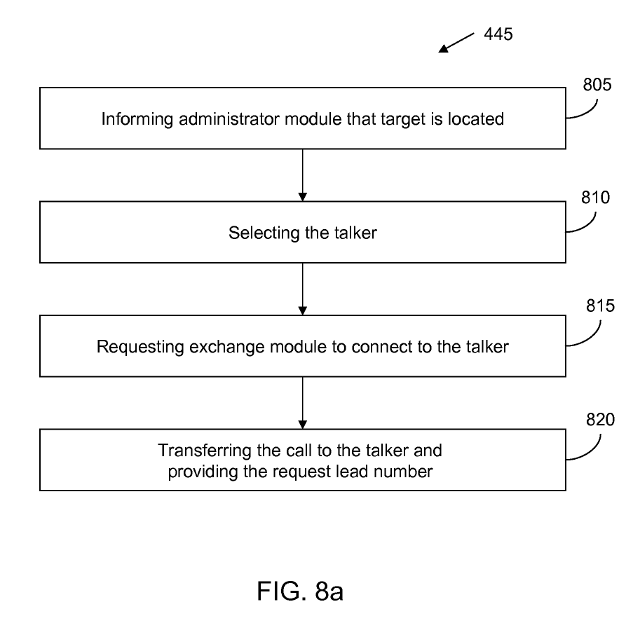

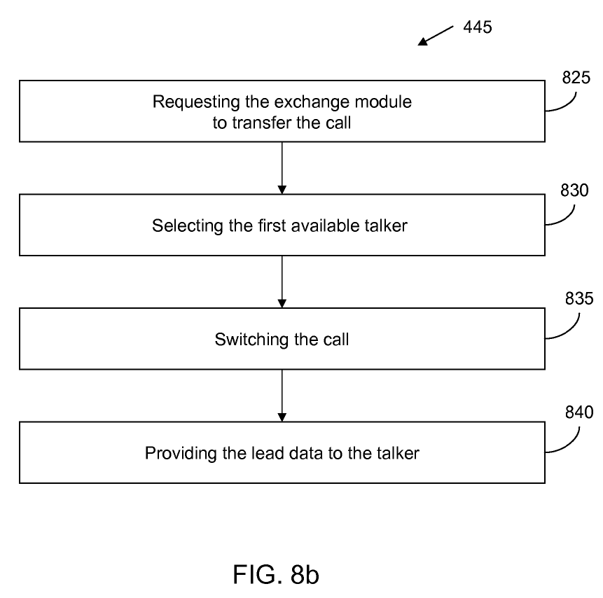

FIG. 8a illustrates the sub-steps of switching the call instantly to the talkers (step 445 of FIG. 4) according to an embodiment of the present invention. Upon reaching the target, the caller module signals the administrator module that the target is located (step 805). In one embodiment, the caller clicks a transfer button immediately upon reaching the target. This signals the administrator module that a transfer should take place. At step 810, the administrator module selects an available talker. In one embodiment of the invention, the administrator module polls the talkers registered in the exchange module to determine the status of each talker. The talker may be polled individually after a predefined time interval. As mentioned, the administrator module polls to find the available talker IP addresses and ports, and selects a talker, optionally according to qualification and abilities, from the available talkers. After selecting the talker, the administrator module requests the exchange module to transfer the call to the talker (step 815). At step 820, the exchange module transfers the call to the talker and provides the request lead number to the talker module. Upon transferring, the exchange module also puts the talker in an auto reject mode. Auto reject prevents the talker from receiving other calls, that is the talker will not be selected again (step 810) until he has completed the call. The exchange module indicates the to the talker that the call is connected via a beep on his phone/headset, and also by displaying the status of the connection on the talker module interface. The talker module uses the lead number to look up the lead data in the database. In one embodiment of the invention, the exchange module provides the lead data to the talker module, and the lead data is displayed at the time the call is transferred so that the talker has complete information about the call.

Immediately after the completion of the call, the talker module places a call to another dummy extension. This causes the talker module to appear busy so that no calls are transferred to the talker. During this time, the talker may enter notes pertaining to the call and provide other information which is updated in the database.

FIG. 8b illustrates the sub-steps of switching the call instantly to the talkers (step 445 of FIG. 4) according to different embodiment of the present invention. Upon reaching the target, the caller module signals the exchange module to transfer the call to the talker (step 825). The exchange module selects the first available talker amongst the available talkers at step 830. The available talkers are registered in the registry module and are not busy with any other call. At step 835, the exchange module switches the call to the selected talker. At step 840, the exchange module provides the lead data to the talker. In one embodiment of the invention, the exchange module provides the lead data through the request lead number which is used to locate and access the lead data in the database.

It should be well understood by now that the talker module, caller module, and administrator module may be software modules running on a computer such as an Intel based desktop or notebook computer belonging to each talker, caller, and administrator. In one embodiment, the software is a stand-alone application that is installed on each computer. In another embodiment, at least some portions of the software are executed in a web browser on each computer and at least some of the software is downloaded from a server, transparent to the caller or talker.

In an embodiment, the talker and the caller may interact with the target using a web-enabled personal digital assistant or other portable mobile device. This allows the talkers and callers to be mobile.

Further modification and enhancements involve selection of callers and talkers. In one embodiment at least one of the caller and the talker is selected based on qualifications, abilities, linguistic preferences include language abilities, knowledge of a product, gender, and experience. Also, a two or more stage caller selection method can be employed. In this method, a caller is selected and call placed as described above. However, some callers may be limited in their ability to navigate due to, for example, their accent or low skill level. In this case, the caller transfers the call to a second agent who is better able to complete the navigation and connect with the target. The second agent transfers the call to the talker when navigation to the target is successful.

Other embodiments modify scheduling calling sessions. In one embodiment, all scheduling is under the control of the administrator. In another embodiment, talkers access a scheduling calendar in the administrator module and schedule the start time and duration of their calling sessions themselves.

Finally, in an embodiment, the call handling system generates reports at the request of the talker module that include for the talker's campaign, for example, a log of calls, descriptions of the calls, frequency of calls, notes, and other data that is useful for evaluating sales efforts. This can be done automatically at the end of a calling session, or can be done at the request of the talker who optionally specifies the content and format of the report. The report may be output in various formats compatible with Customer Relationship Management (CRM) software and application. In this case, the report is directly importable to CRM applications. In one embodiment, the reports are compatible with CRM applications from Salesforce.com. In another embodiment, the report generation is directly integrated with popular industry standard CRM solutions. In this embodiment, generating a report includes automatically importing that report into the CRM solution. The reports may be output in other formats so that can they be published or other accessed over the Internet, and take the form of an XML file or syndicated feed compatible with RSS news readers.

The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

In the foregoing description, specific embodiments of the present invention have been described by way of examples with reference to the accompanying figures and drawings. One of ordinary skill in the art will appreciate that various modifications and changes may be made to the embodiments without departing from the scope of the present invention as set forth in the claims below. Accordingly, the specification and figures are to be regarded in an illustrative rather than a restrictive sense, and all such modifications are intended to be included within the scope of the present invention.

The foregoing detailed description has set forth a few of the many forms that this invention can take. It is intended that the foregoing detailed description be understood as an illustration of selected forms that the invention can take and not as a limitation to the definition of the invention. It is only the following claims, including all equivalents that are intended to define the scope of this invention.

What is claimed is:

1. A system for facilitating a call connection between a talker and a target, the system comprising:
a database that maintains a list of lead data of one or more targets;
an exchange module that maintains real-time connectivity between a caller and the talker after the caller and the talker are registered with the exchange module;
at least one caller module that places at least one of a call set up request and a call transfer request to the exchange module, wherein the call transfer request is placed when the target is located on the call, the caller module further in communication with the database to obtain the lead data of the target after the call is set up; and
at least one talker module that receives the call from the exchange module in response to the call transfer request by the caller module along with the lead data of the target.

2. The system of claim 1 wherein the exchange module comprises a registry module that stores registration details of the talker and the caller.

3. The system of claim 1 further comprising an administrator module in communication with the exchange module, the database, and the talker module.

4. The system of claim 3 wherein the administrator module loads the lead data of the targets into the database.

5. The system of claim 3 wherein the administrator module updates the list of targets stored in the database.

6. The system of claim 3 wherein the administrator module prepares a campaign by selecting the lead data of the targets.

7. The system of claim 3 wherein the administrator module comprises a polling module in communication with the exchange module to determine status of the at least one of the caller module and the at least one talker module.

8. The system of claim 7 wherein the administrator module further comprises a distribution module to distribute calls to the caller modules, the distribution module comprising:
a first checking module to check whether a request lead number received from the polling module conforms to a request lead number stored by the administrator module;
a second checking module to determine whether a talker module is available; and
an assignment module to assign lead data to the caller module corresponding to a new target if the first check is unsuccessful and the second check is successful.

9. The system of claim 1 wherein the exchange module comprises one of a software private branch exchange (PBX) and a voice over Internet protocol (VoIP) hosted exchange module.

10. The system of claim 9 wherein the software PBX is supported by a server using a Real Time Operating System (RTOS).

11. The system of claim 1 wherein the exchange module provides instant call transfer via at least one of a circuit-switched connection and a packet-switched connection.

12. The system of claim 1 wherein the caller module updates the lead data in the database.

13. The system of claim 1 wherein the talker module updates the list of the targets in the database.

14. The system of claim 1 wherein the talker module signals the administrator module about its availability.

15. The system of claim 1 wherein at least one of the caller, the talker, and the target are located in distinct geographical areas.

16. The system of claim 1 wherein the caller, the talker, and the target are located in a common geographical area.

17. The system of claim 1 wherein the caller and the talker are each one of a human agent or a voice recognition system.

18. The system of claim 1 wherein the lead data of a target comprises at least one of the name, phone number, time zone, frequency of calls, company name, job title, position, notes, and designation of the target.

19. The system of claim 1 wherein the talker module is executed on a web-enabled personal digital assistant (PDA).

20. The system of claim 1 wherein the at least one of caller and talker are selected based on at least one of: qualifications, abilities, linguistic preferences, knowledge of a product, gender, and experience.

21. A method for facilitating a call connection between a talker and a target, the method comprising:
maintaining real-time connectivity between a caller and the talker after the caller and the talker are registered;
receiving a call set up request from the caller and providing lead data of the target after the call is set up to the caller;
receiving a call transfer request from the caller when the target is located on the call after navigation; and
instantly switching the call from the caller to the talker in response to the call transfer request along with the lead data of the target.

22. The method of claim 21 further comprising providing the caller an option, the option comprising at least one of rejecting a call corresponding to a target, redialing the call to the target, placing the call on hold, leaving a pre-recorded message, and pausing the call.

23. The method of claim 21 further comprising maintaining a list of the lead data of at least one target.

24. The method of claim 21 further comprising instantly transferring the call to the caller upon detection of one of a voicemail or a voice of the target.

25. The method of claim 21 further comprising receiving an additional list of the lead data of the targets from the talker.

26. The method of claim 21 further comprising enabling the caller to update the list of targets.

27. The method of claim 21 further comprising maintaining call notes of at least one of the caller and the talker after completion of the call with the target.

28. The method of claim 21 wherein the navigation comprises updating the lead data of the target.

29. The method of claim 21 further comprising preparing a campaign by selecting the lead data of the targets.

30. The method of claim 21 further comprising determining a status of at least one of the registered caller and the registered talker.

31. The method of claim 21 comprising distributing the calls to the registered caller, the distributing comprising:
checking whether a determined request lead number conforms with an assigned request lead number;
determining whether a registered talker is available; and
assigning lead data to the registered caller corresponding to a new target upon unsuccessful check and successful determination.

32. The method of claim 21 further comprising scheduling a calling session with the target by logging into a calendar which displays time and date availability.

33. The method of claim 21 further comprising generating a report.

34. The method of claim 21 wherein at least one of the caller, the talker, and the target are located in distinct geographical areas.

35. The method of claim 21 wherein the caller, the talker, and the target are located in a common geographical area.

36. The method of claim 21 wherein the caller and the talker are each one of a human agent or a voice recognition system.

37. A computer program product comprising a computer readable medium including a computer readable program, wherein the computer readable program when executed on a computer causes the computer to:
maintain real-time connectivity between a caller and the talker after the caller and the talker are registered;
receive a call set up request from the caller and provide lead data of a target after the call set up to the caller;
receive a call transfer request from the caller when the target is located on the call after navigation; and
instantly switch the call from the caller to the talker in response to the call transfer request along with the lead data of the target.

38. The computer program product of claim 37 further comprising a computer readable program for monitoring activities of the registered caller and the registered talker.

39. The computer program product of claim 37 further comprising a computer readable program for preparing a campaign.

40. The computer program product according to claim 37 further comprising a computer readable program for determining status of at least one of the registered caller and the registered talker.

41. The computer program product according to claim 37 further comprising a computer readable program for generating a report.

42. A method for facilitating a call connection between a talker and a target, the method comprising:
maintaining a list of the lead data of at least one target;
maintaining real-time connectivity between a caller and the talker after the caller and the talker are registered;
receiving a call set up request from the caller and providing the lead data of the target after the call is set up to the caller;
updating the lead data of the target;
receiving a call transfer request from the caller when the target is located on the call after navigation;
determining a status of the registered talker; and
instantly switching the call from the caller to the talker in response to the call transfer request along with the lead data of the target when the registered talker is available.
